(19) United States
(12) Patent Application Publication
(10) Pub. No.: US 2011/0051846 A1
(43) Pub. Date: Mar. 3, 2011

(54) Processing EM Bands

(75) Inventors: Stephen Gilbert, Madison, AL (US); Ronnie Moore, Huntsville, AL (US); Jeyaprakash Soundrapandian, Tamilnadu (IN); Pavan K. Hanumantharaya, Austin, TX (US); Yogesh Patil, Huntsville, AL (US)

(73) Assignee: Continental Automotive Systems US, Inc., Auburn Hills, MI (US)

(21) Appl. No.: 12/549,514

(22) Filed: Aug. 28, 2009

(51) Int. Cl. H04L 27/00

(52) U.S. Cl. 375/316

(57) ABSTRACT

Methods and systems for processing an electromagnetic (EM) band are disclosed, including receiving a digitized EM band comprising two or more channels where two or more of the channels comprise modulated information; receiving two or more selections of two or more of the channels from two or more users; and demodulating the information from the selected channels.

### I. BACKGROUND

The invention relates generally to the field of decoding and processing modulated information stored in electromagnetic (EM) bands.

### II. SUMMARY

In one respect, disclosed is a method for processing an electromagnetic (EM) band, the method comprising: receiving a digitized EM band comprising two or more channels where two or more of the channels comprise modulated information; receiving two or more selections of two or more of the channels from two or more users; and demodulating the information from the selected channels.

In another respect, disclosed is a device for processing an EM band, the device comprising: one or more processors; one or more memory units coupled to the one or more processors; the device being configured to: receive a digitized EM band comprising two or more channels where two or more channels comprise modulated information; receive two or more selections of two or more of the channels from two or more users; and demodulate the information from the selected channels.

In yet another respect, disclosed is a computer program product for processing an electromagnetic (EM) band, the computer program product being stored on a computer-operable medium and comprising software code being effective to: receive a digitized EM band comprising two or more channels where two or more of the channels comprise modulated information; receive two or more selections of two or more of the channels from two or more users; and demodulate the information from the selected channels.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a flow diagram illustrating a method for processing an electromagnetic (EM) band comprising two or more channels that comprise modulated information, in accordance with some embodiments.

FIG. 2 is a flow diagram illustrating a method for processing multiple EM bands, each EM band comprising two or more channels that comprise modulated information, in accordance with some embodiments.

FIG. 3 is a block diagram illustrating a system for processing one or more EM bands, each EM band comprising two or more channels that comprise modulated information, in accordance with some embodiments.

FIG. 4 is a block diagram illustrating an alternative system for processing one or more EM bands, each EM band comprising two or more channels that comprise modulated information, in accordance with some embodiments.

FIG. 5 is a block diagram illustrating an alternative system for processing one or more EM bands, each EM band comprising two or more channels that comprise modulated information, in accordance with some embodiments.

FIG. 6 is a block diagram illustrating a digital signal processor (DSP) or application-specific integrated circuit (ASIC) for processing one or more EM bands, each EM band comprising two or more channels that comprise modulated information, in accordance with some embodiments.

FIG. 7 is a block diagram illustrating alternative embodiments of a vehicle configured to receive, process, and play or display multiple EM bands, each EM band comprising two or more channels that comprise modulated information, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In some embodiments, a digitized EM band comprising two or more channels, where two or more of the channels comprise modulated information, is received for processing. In some embodiments, the modulated information might include one or more of the following types of data: audio, video, and general data in binary format.

In alternative embodiments, multiple EM bands, which can each be processed substantially concurrently, are received by one or more antennae from one or more sources, such as broadcast towers or satellites. The multiple EM bands could then be amplified, filtered, and then digitized for further processing. In some embodiments, two or more selections of channels, modulation protocols, and/or EM bands are received from two or more users whenever the two or more users want to make such channel, modulation protocol, and/or EM band selections. In alternative embodiments, the bands are demodulated using one or more demodulation protocols and using hardware, software, or a combination of hardware and software. In other embodiments, the demodulated information can then be sent to the two or more users according to the users' selections. For example, audio information could be played for the two or more users, or video information could be displayed visually for the two or more users. In still other embodiments, the demodulated information can be stored for later use.

In additional embodiments, each of the one or more EM bands might comprise modulated information that was encoded using multiple modulation protocols. In some embodiments, radio broadcast modulation protocols might include analog radio, digital radio, analog AM (Amplitude Modulation) radio, analog FM (Amplitude Modulation) radio, digital AM HD (high-definition) radio, digital FM HD radio, RBDS (Radio Broadcast Data System), and RDS (Radio Data System).

In some embodiments, two or more users select two or more channels. The two or more users can make different channel selections at later times whenever they wish to do so.

In alternative embodiments that include multiple modulation protocols, as described above in [¶18], the two or more users can select two or more channels as well as one or more modulation protocols or one or more EM bands. The two or more users can make different channel, modulation protocol, and/or EM band selections at later times whenever the two or more users wish to do so.

In some embodiments, the modulated information from the two or more selected channels is demodulated. In alternative embodiments, the modulated information from the two or more selected channels is demodulated substantially concurrently in serial fashion using a single demodulator.

In some embodiments, the demodulated information is sent to the users according to the users' respective selections.

In some embodiments in which the demodulated information comprises audio data, the demodulated audio data can be converted from digital to analog format and then played for the two or more users via two or more audio speakers, based upon the users' respective selections.

In some embodiments in which the demodulated information comprises video data, the demodulated video data can be displayed for the two or more users on monitors, screens, or other visual display devices, based upon the users' respective selections.

In alternative embodiments, the demodulated information may stored temporarily or permanently for later use on one or more storage devices and/or storage media, such as computer volatile memory, computer hard disk drives, USB flash drives, CDs, DVDs, etc.

In some embodiments, an updated list or database of one or more supported modulation protocols and their respective methods for demodulation can be received. In this fashion, new modulation protocols can be easily and flexibly incorporated essentially in real time without users or service personnel having to make hardware changes. Similarly, modulation protocols could be removed from availability simply by removing those protocols' entries from the list or database of supported protocols.

In some embodiments, the one or more EM bands comprising modulated information are received using one or more physical antennae.

In some embodiments, a multi-channel receiver front-end unit is used to provide initial processing of one or more received EM bands.

In alternative embodiments, the one or more received EM bands are passed into one or more amplifiers, which are used to amplify or attenuate the signals of the received EM bands.

In alternative embodiments, the one or more (possibly amplified) EM bands are passed into one or more filters, which are used to filter the signals of the received EM bands, according to the EM bands' respective modulation protocols.

In some embodiments, a multi-channel receiver back-end unit is used to demodulate the one or more received EM bands.

In some embodiments, a microcontroller unit is used to accept selections and commands from the two or more users and to send the selections and commands and any other required parameters to the rest of the system. In some embodiments, the microcontroller unit is part of the multi-channel receiver back-end unit; in other embodiments, the microcontroller unit could be external to both the multi-channel receiver front-end unit and the multi-channel receiver back-end unit.

In some embodiments, the multi-channel receiver back-end unit might comprise one or more analog-to-digital converters, which convert the received (and possibly amplified and/or filtered) EM bands into digital format, and one or more processors coupled to one or more memory units, which together are operative to demodulate the modulated information from the received EM bands.

In alternative embodiments, the multi-channel receiver back-end unit might comprise one or more analog-to-digital converters, which convert the received (and possibly amplified and/or filtered) EM bands into digital format; one or more switches, which send the digitized EM bands to one or more downconverters, or decimators, which then reduce the data size of the digitized EM bands; one or more optional digital filters, which subsequently filter the decimated EM bands; a channel multiplexing and interfacing unit, which agglomerates the filtered EM bands into a unified data stream for further processing; and a multi-channel processing unit, which demodulates the data stream comprising the pre-processed EM bands.

In some embodiments involving modulated audio data, the multi-channel processing unit separates the demodulated data stream comprising the received EM bands by channel and/or modulation protocol and then sends the separate, demodulated audio EM bands to one or more digital-to-analog converters, which subsequently send the analog signals to one or more audio speakers, which then play the demodulated audio signals for the one or more users, according to the users' respective channel and/or modulation protocol selections.

In some embodiments involving modulated video data, the multi-channel audio processing unit separates the demodulated data stream comprising the received EM bands by channel and/or modulation protocol and then sends the separate, demodulated video EM bands to one or more visual display devices, which then display the demodulated video signals for the one or more users, according to the users' respective channel and/or modulation protocol selections.

In alternative embodiments, the demodulated EM bands are sent to other types of output devices, such as storage devices, storage media, or any other type of output device capable of receiving the demodulated EM bands.

In some embodiments, the switching, downconverting, filtering, and demodulating functions described above in [¶34] can be performed using specialized hardware, such as one or more digital signal processors (DSPs) and/or one or more application-specific integrated circuits (ASICs).

In some embodiments, the one or more digital signal processors (DSPs) and/or one or more application-specific integrated circuits (ASICs) could comprise one or more demodulators/decoders; one or more data services units, which maintain the database of supported modulation protocols and corresponding demodulation methods; and one or more automatic gain controllers (AGCs), which monitor the output levels of the demodulated EM bands and then dynamically adjust the gain or attenuation of the one or more amplifiers in the multi-channel receiver front-end unit in order to optimize the signal-to-noise ratio of the system.

In alternative embodiments, the switching, downconverting, filtering, and demodulating functions described above in [¶34] can be performed using software running on a standard computer central processing unit (CPU).

In yet other embodiments, the processing described above can be performed using a combination of software and specialized hardware.

In some embodiments, the multi-channel demodulation of the received EM bands is performed in one or more of the following usage environments: automobiles, trains, subways, airplanes, ships, boats, motor homes, houses, apartments, condominiums, office building, or other kinds of buildings.

In some embodiments, the multi-channel demodulation of the received EM bands is performed in the context of an automotive radio system, which receives one or more EM bands from radio broadcast sources (such as broadcast towers or satellites) using one or more antennae, accepts user input from one or more control interfaces in the car, processes and demodulates the received EM bands, and then plays the demodulated EM bands for the users on one or more audio speakers in the automobile.

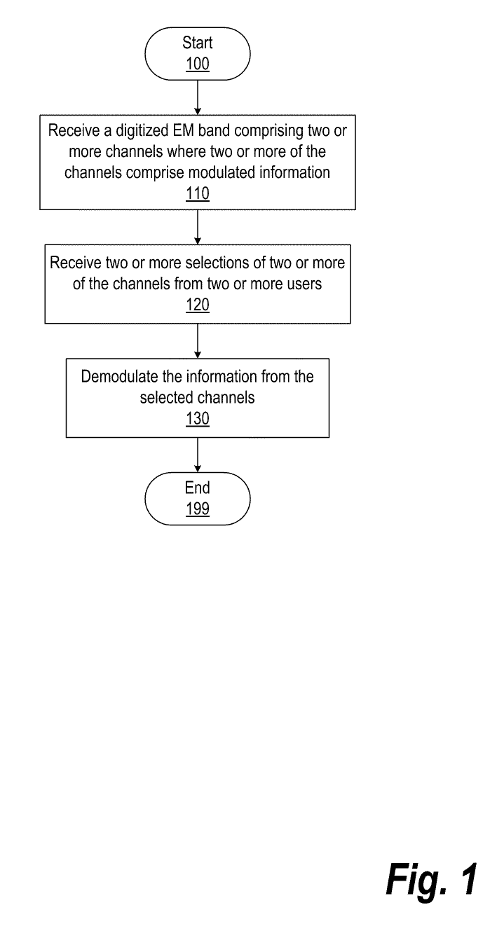

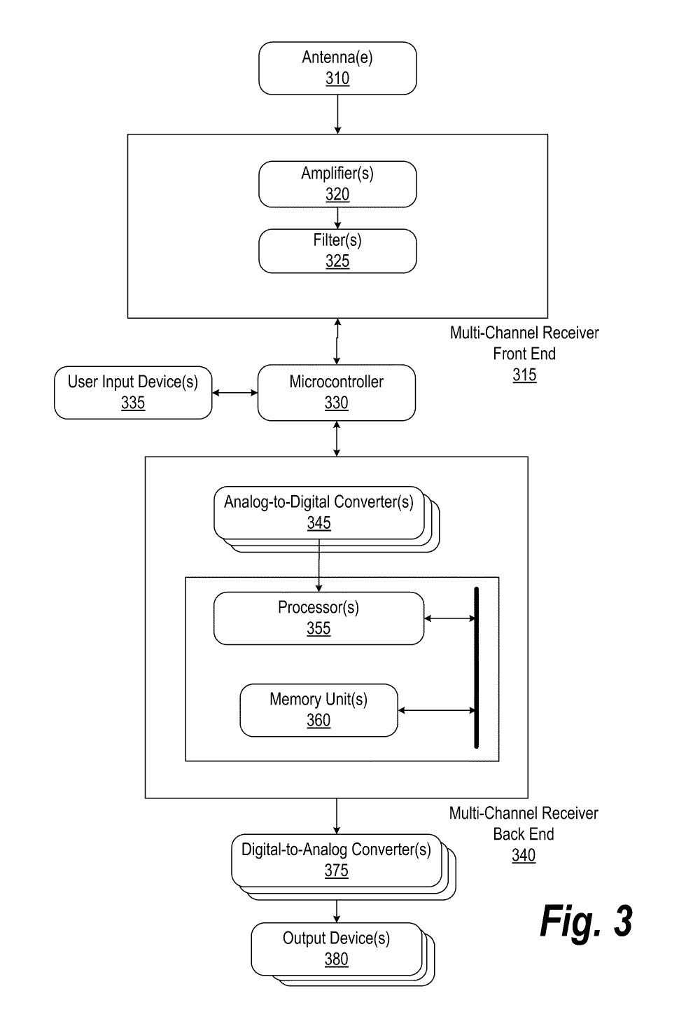

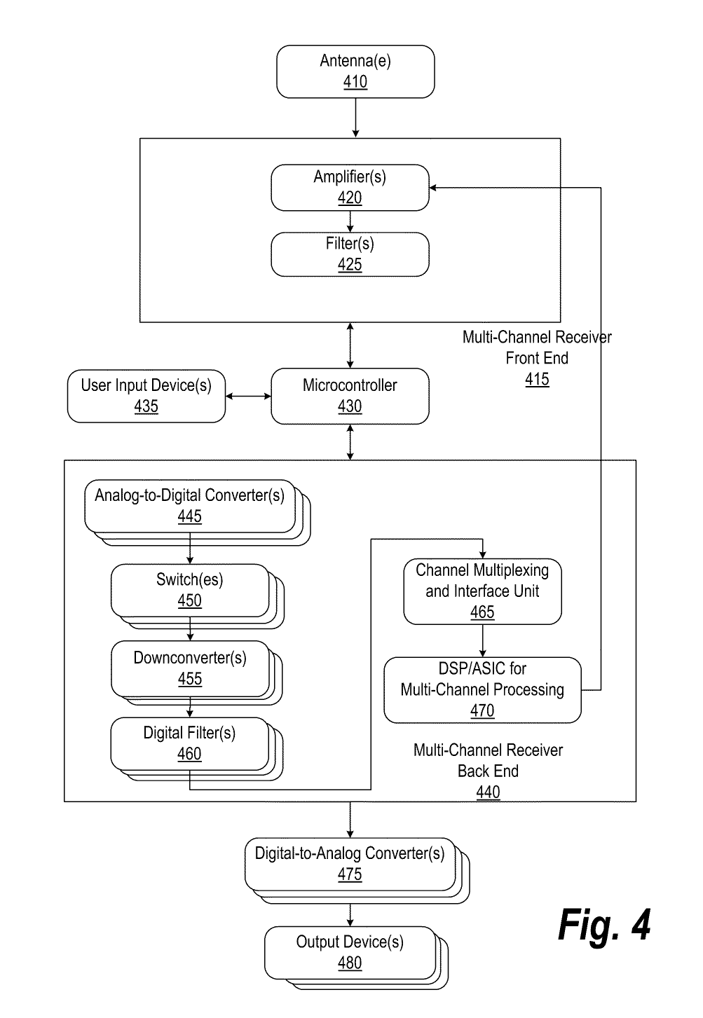

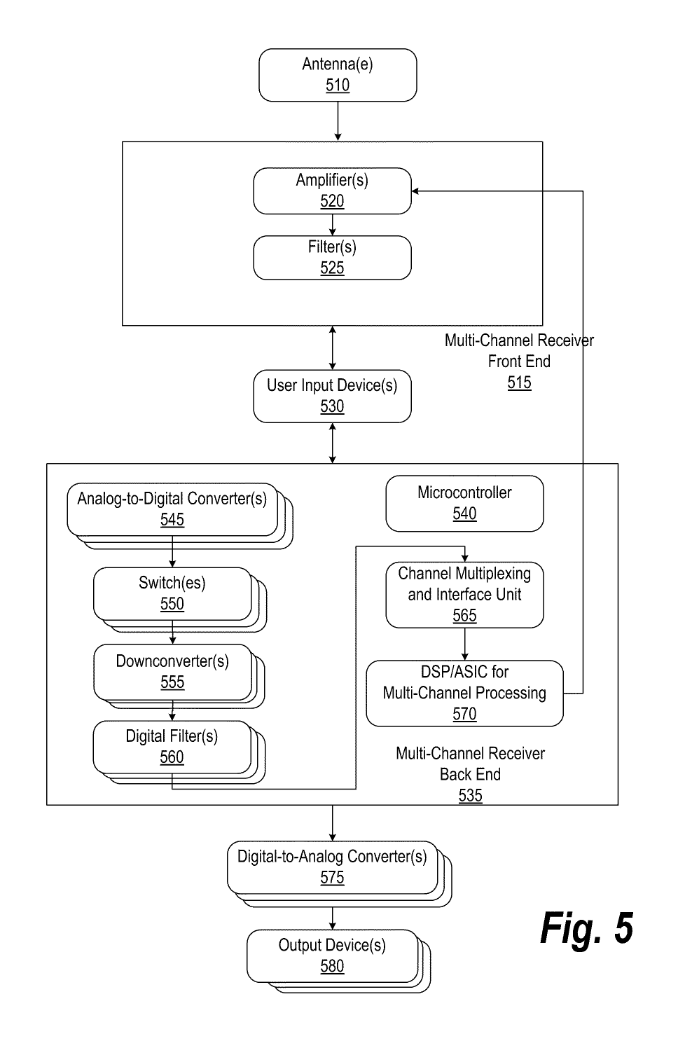

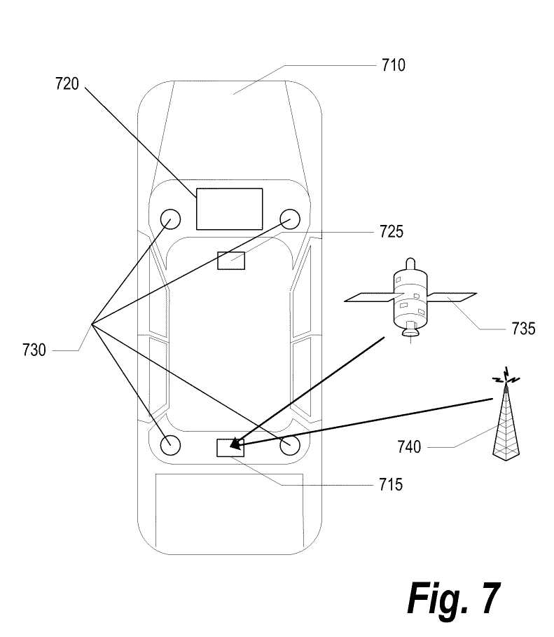

FIG. 1 is a flow diagram illustrating a method for processing an electromagnetic (EM) band comprising two or more channels that comprise modulated information, in accordance with some embodiments. In some embodiments, the method illustrated in FIG. 1 may be performed by one or more of the systems illustrated in FIG. 3, FIG. 4, FIG. 5, and FIG. 7. Processing begins at 100 whereupon, at block 110, a digitized EM band comprising two or more channels, where two or more of the channels comprise modulated information, is received. At block 120, two or more selections of two or more of the channels from two or more users are received. At block 130, the information from the selected channels is demodulated. Processing subsequently ends at 199.

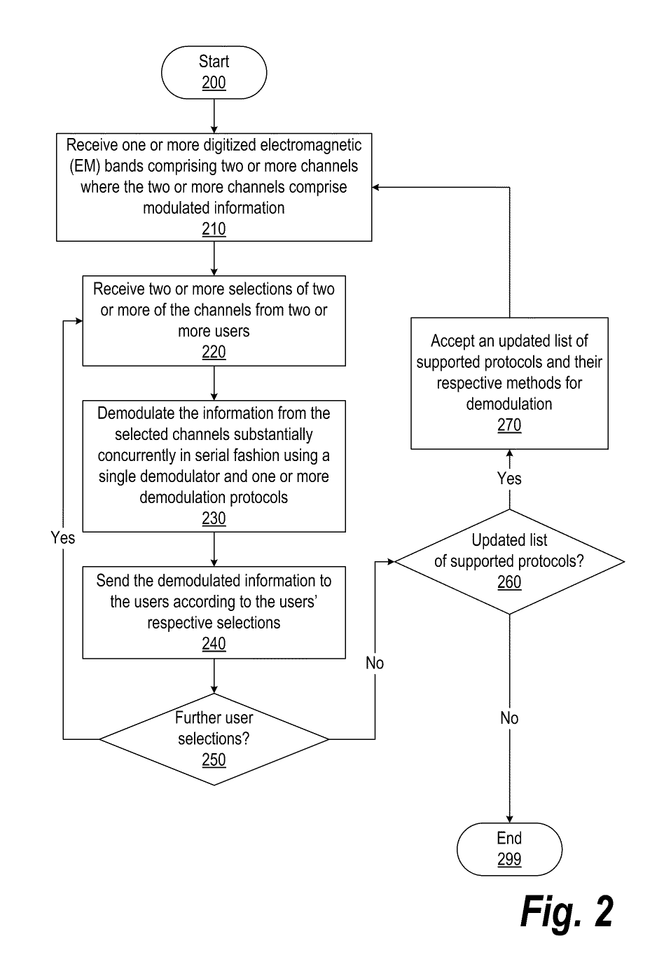

FIG. 2 is a flow diagram illustrating a method for processing multiple EM bands, each EM band comprising two or more channels that comprise modulated information, in accordance with some embodiments. In some embodiments, the method illustrated in FIG. 2 may be performed by one or more of the systems illustrated in FIG. 3, FIG. 4, FIG. 5, and FIG. 7.

Processing begins at 200 whereupon, at block 210, one or more digitized EM bands comprising two or more channels, where two or more of the channels comprise modulated information, are received. At block 220, two or more selections of two or more of the channels from two or more users are received. At block 230, the information from the selected channels is demodulated substantially concurrently in serial fashion using a single demodulator and one or more demodulation protocols. At block 240, the demodulated information is sent to the users according to the users' respective selections.

If there are further user selections available, decision 250 branches to the “Yes” branch where processing returns to block 220 in order receive the new selections from the two or more users. Returning to decision 250, if there are currently no further user selection, decision 250 branches to the “No” branch, whereupon processing again continues at decision 260.

If there is an updated list of supported protocols available, decision 260 branches to the “Yes” branch where processing moves to block 270, at which point an updated list of supported protocols and their respective methods for demodulation is accepted for use by the system. Subsequently, processing returns to block 210, where one or more EM bands are received using the updated protocol information.

Returning to decision 260, if there is not an updated list of supported protocols available, decision 260 branches to the “No” branch, whereupon processing subsequently ends at 299.

FIG. 3 is a block diagram illustrating a system for processing one or more EM bands, each EM band comprising two or more channels that comprise modulated information, in accordance with some embodiments. In some embodiments, the system illustrated in FIG. 3 could perform one or more of the methods illustrated in FIG. 1 and FIG. 2.

In some embodiments, the system could comprise one or more antennae 310, a multi-channel receiver front end 315, a microcontroller 330, one or more user input devices 335, a multi-channel receiver back end 340, one or more optional digital-to-analog converters 375, and one or more output devices 380, all of which are directly or indirectly coupled to each other. The one or more antennae 310 are operative to receive one or more EM bands comprising two or more channels, where two or more of the channels comprise modulated information. Within the multi-channel receiver front end 315, the received EM bands can be amplified or attenuated by one or more amplifiers 320 and then possibly filtered by one or more filters 325.

In some embodiments, the one or more user input devices 335 accept channel and protocol selections as well as other system commands from the two or more users of the system. The microcontroller 330 performs overall command and control functions for the system and routes data among the multi-channel receiver front end 315, the one or more user input devices 335, and the multi-channel receiver back end 340. In some embodiments, multi-channel receiver front end 315 sends the received EM bands to the multi-channel receiver back end 340 either directly or indirectly via the microcontroller 330.

In some embodiments, the multi-channel receiver back end 340 comprises one or more analog-to-digital converters 345, one or more processors 355, and one or more memory units 360, all of which are directly or indirectly coupled to each other. In some embodiments, the switching, downconverting, filtering, and demodulating functions described in the method of FIG. 2 are performed collectively by the one or more processors 355 and the one or more memory units 360.

In some embodiments, the multi-channel receiver back end 340 sends the demodulated channels to one or more optional digital-to-analog converters 375, which convert the demodulated data from digital to analog format and then send the converted data to the one or more output devices 380. In alternative embodiments that do not include the optional digital-to-analog converters 375, the multi-channel receiver back end 340 may send the demodulated data directly to the one or more output devices 380.

FIG. 4 is a block diagram illustrating an alternative system for processing one or more EM bands, each EM band comprising two or more channels that comprise modulated information, in accordance with some embodiments. In some embodiments, the system illustrated in FIG. 4 could perform one or more of the methods illustrated in FIG. 1 and FIG. 2.

In some embodiments, the system could comprise one or more antennae 410, a multi-channel receiver front end 415, a microcontroller 430, one or more user input devices 435, a multi-channel receiver back end 440, one or more optional digital-to-analog converters 475, and one or more output devices 480, all of which are directly or indirectly coupled to each other. The one or more antennae 410 are operative to receive one or more EM bands comprising two or more channels, where two or more of the channels comprise modulated information. Within the multi-channel receiver front end 415, the received EM bands can be amplified or attenuated by one or more amplifiers 420 and then possibly be filtered by one or more filters 425.

In some embodiments, the one or more user input devices 435 accept channel and protocol selections as well as other system commands from the two or more users of the system. The microcontroller 430 performs overall command and control functions for the system and routes data among the multi-channel receiver front end 415, the one or more user input devices 435, and the multi-channel receiver back end 440. In some embodiments, the multi-channel receiver front end 415 sends the received EM bands to the multi-channel receiver back end 440 either directly or indirectly via the microcontroller 430.

In some embodiments, the multi-channel receiver back end 440 comprises one or more analog-to-digital converters 445, one or more switches 450, one or more downconverters 455, one or more digital filters 460, a channel multiplexing and interface unit 465, and a digital signal processor (DSP) or application-specific integrated circuit (ASIC) for multi-channel processing 470, all of which are directly or indirectly coupled to each other.

In some embodiments, within the multi-channel receiver back end 440, one or more analog-to-digital converters 445 convert the received EM bands from analog to digital format for further processing. The one or more switches 450 each independently select a specific modulation protocol for the EM bands, according to the users' selections received by the one or more user input devices 435. In some embodiments, the output of each of the one or more switches 450 is connected to one of the one or more downconverters 455. The one or more downconverters 455 serve to select specific channels out of the full set of received channels, according to the users' respective channel selections and then, in some embodiments, to translate each selected channel to a frequency of zero Hertz. The number of simultaneously selectable channels is limited only by the number of available downconverters 455. In some embodiments, the one or more downconverters 455 additionally perform decimation to reduce the digital sampling rate of the channels' data to allow for more efficient signal processing of the selected channels.

In some embodiments, the one or more downconverters 455 send the downconverted (and possibly decimated) channel data to the one or more digital filters 460, which filter the selected channels to optimize the signal-to-noise ratio for the selected channels. In some embodiments, the one or more digital filters 460 can have their filter parameters (such as bandwidth, attenuation, gain, filter structure, filter order, etc.) controlled by a user command and control interface to the microcontroller 430.

In some embodiments, the output of the one or more digital filters 460 is used as the input for a channel multiplexing and interface unit 465, which serves to combine the processed channel data into a single data stream that contains the data from all the received channels.

In some embodiments, the combined output of the channel multiplexing and interface unit 465 is used as the input for the DSP/ASIC for multi-channel processing 470. The DSP/ASIC for multi-channel processing 470 decodes and demodulates the data received from the channel multiplexing and interface unit 465.

In some embodiments, the multi-channel receiver back end 440 sends the demodulated data from the received EM channels to one or more optional digital-to-analog converters 475, which convert the demodulated data from digital to analog format and then send the converted data to the one or more output devices 480. In alternative embodiments that do not include the optional digital-to-analog converters 475, the multi-channel receiver back end 440 may send the demodulated data directly to the one or more output devices 480.

In some embodiments, the one or more output devices 480 could comprise audio speakers, audio headphones, video screens, as well as general storage devices and storage media, such as computer volatile memory, computer hard disk drives, USB flash drives, CDs, DVDs, etc.

FIG. 5 is a block diagram illustrating an alternative system for processing one or more EM bands, each EM band comprising two or more channels that comprise modulated information, in accordance with some embodiments. In some embodiments, the system illustrated in FIG. 5 could perform one or more of the methods illustrated in FIG. 1 and FIG. 2.

In some embodiments, the system could comprise one or more antennae 510, a multi-channel receiver front end 515, one or more user input devices 530, a multi-channel receiver back end 535, one or more optional digital-to-analog converters 575, and one or more output devices 580, all of which are directly or indirectly coupled to each other. The one or more antennae 510 are operative to receive one or more EM bands comprising two or more channels, where two or more of the channels comprise modulated information. Within the multi-channel receiver front end 515, the received EM bands can be amplified or attenuated by one or more amplifiers 520 and then possibly be filtered by one or more filters 525.

In some embodiments, the one or more user input devices 530 accept channel and protocol selections as well as other system commands from the two or more users of the system. In some embodiments, the multi-channel receiver front end 515 sends the received EM bands to the multi-channel receiver back end 535 for processing.

In some embodiments, the multi-channel receiver back end 535 comprises a microcontroller 540, one or more analog-to-digital converters 545, one or more switches 550, one or more downconverters 555, one or more digital filters 560, a channel multiplexing and interface unit 565, and a digital signal processor (DSP) or application-specific integrated circuit (ASIC) for multi-channel processing 570, all of which are directly or indirectly coupled to each other. The microcontroller 540 performs overall command and control functions for the system and routes data among the multi-channel receiver front end 515, the one or more user input devices 530, and the other components within the multi-channel receiver back end 535.

In some embodiments, within the multi-channel receiver back end 535, one or more analog-to-digital converters 545 convert the received EM bands from analog to digital format for further processing. The one or more switches 550 each independently select a specific modulation protocol for the EM bands, according to the users' selections received by the one or more user input devices 530. In some embodiments, the output of each of the one or more switches 550 is connected to one of the one or more downconverters 555. The one or more downconverters 555 serve to select specific channels out of the full set of received channels, according to the users' respective channel selections and then, in some embodiments, to translate each selected channel to a frequency of zero Hertz. The number of simultaneously selectable channels is limited only by the number of available downconverters 555. In some embodiments, the one or more downconverters 555 additionally perform decimation to reduce the digital sampling rate of the channels' data to allow for more efficient signal processing of the selected channels.

In some embodiments, the one or more downconverters 555 send the downconverted (and possibly decimated) channel data to the one or more digital filters 560, which filter the selected channels to optimize the signal-to-noise ratio for the selected channels. In some embodiments, the one or more digital filters 560 can have their filter parameters (such as bandwidth, attenuation, gain, filter structure, filter order, etc.) controlled by a user command and control interface to the microcontroller 540.

In some embodiments, the output of the one or more digital filters 560 is used as the input for a channel multiplexing and interface unit 565, which serves to combine the processed channel data into a single data stream that contains the data from all the received channels.

In some embodiments, the combined output of the channel multiplexing and interface unit 565 is used as the input for the DSP/ASIC for multi-channel processing 570. The DSP/ASIC for multi-channel processing 570 decodes and demodulates the data received from the channel multiplexing and interface unit 565.

In some embodiments, the multi-channel receiver back end 535 sends the demodulated data from the received EM channels to one or more optional digital-to-analog converters 575, which convert the demodulated data from digital to analog format and then send the converted data to the one or more output devices 580. In alternative embodiments that do not include the optional digital-to-analog converters 575, the multi-channel receiver back end 535 may send the demodulated data directly to the one or more output devices 580.

In some embodiments, the one or more output devices 580 could comprise audio speakers, audio headphones, video screens, as well as general storage devices and storage media, such as computer volatile memory, computer hard disk drives, USB flash drives, CDs, DVDs, etc.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

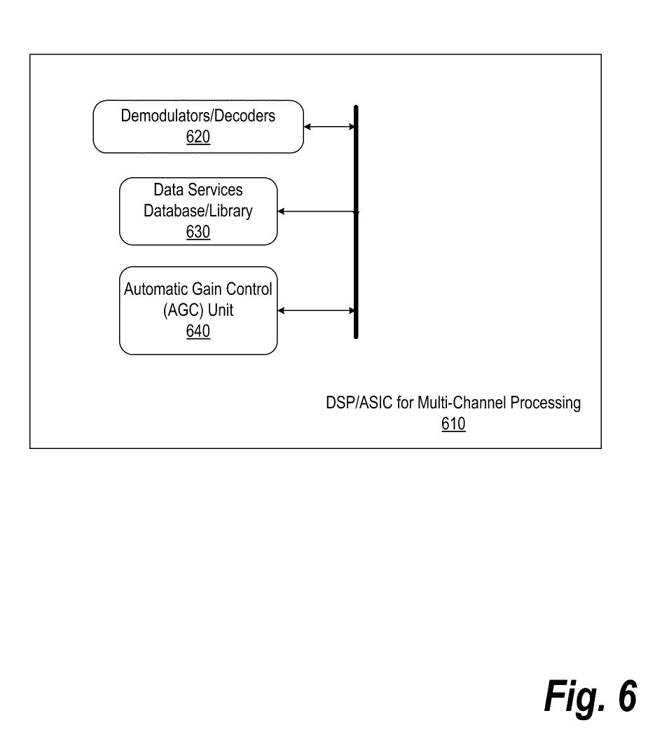

FIG. 6 is a block diagram illustrating a digital signal processor (DSP) or application-specific integrated circuit (ASIC) for processing one or more EM bands, each EM band comprising two or more channels that comprise modulated information, in accordance with some embodiments. In some embodiments, the device illustrated in FIG. 6 could be used as a component within the systems described in FIG. 4 and FIG. 5.

In some embodiments, the DSP/ASIC for multi-channel processing 610 depicted in FIG. 6 could comprise one or more demodulators/decoders 620, a data services database/library 630, and an automatic gain controller (AGC) unit 640. In alternative embodiments, the data services database/library 630, and an automatic gain controller (AGC) unit 640 could be external to but still coupled to the DSP/ASIC for multi-channel processing 610.

The one or more demodulators/decoders 620 operate to decode or demodulate the pre-processed data for the selected channels, which, in some embodiments, are supplied as the output from the channel multiplexing and interface unit 465 or the channel multiplexing and interface unit 565 in the systems of FIG. 4 and FIG. 5, respectively.

In some embodiments, the data services database/library 630 serves to maintain the set of supported modulation protocols and the modulation protocols' corresponding demodulation methods implemented in software, hardware, or a combination thereof. The one or more demodulators/decoders 620 can use any of the supported protocols or standards maintained in the data services database/library 630. This type of flexible, component-based architecture allows for the system to incorporate new services, protocols, and standards very easily and quickly, without the need for hardware changes.

In some embodiments, the automatic gain controller (AGC) unit 640 serves to provide the desired signal-to-noise ratio for the system by monitoring the relative levels of the received EM bands and then by sending commands to the multi-channel receiver front end 315 (or 415 or 515, in alternative embodiments) to dynamically adjust the gain or attenuation settings of the one or more amplifiers 320 (or 420 or 520, in alternative embodiments). In some embodiments, the AGC unit 640 can send the adjustments commands directly the multi-channel receiver front end 315 or indirectly through the microcontroller 330 (or 430 or 540), the analog-to-digital converters 345 (or 445 or 545), or downconverters 455 (or 555).

FIG. 7 is a block diagram illustrating alternative embodiments of a vehicle configured to receive, process, and play or display multiple EM bands, each EM band comprising two or more channels that comprise modulated information, in accordance with some embodiments. In some embodiments, the system illustrated in FIG. 7 could perform one or more of the methods illustrated in FIG. 1 and FIG. 2.

In some embodiments, vehicle 710 is configured with one or more antennae 715, a multi-channel processing unit 720, one or more user control units 725, and one or more output devices 730 (such as audio speakers or visual displays, for example), which may be placed at different locations throughout the vehicle 710. The one or more antennae 715 receive EM bands transmitted by multiple sources, for example, by satellite 735 or broadcast tower 740. In some embodiments, multi-channel processing unit 720 effectively incorporates the EM channel processing functions of both the multi-channel receiver front end 515 and multi-channel receiver front end 535 from FIG. 5. The resulting output can be sent to the users using the one or more output devices 730, according to the users' respective channel and modulation protocol selections, which are accepted by the one or more user control units 725.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for processing an electromagnetic (EM) band, the method comprising:
receiving a digitized EM band comprising two or more channels where the two or more of the channels comprise modulated information;
receiving two or more selections of two or more of the channels from two or more users; and
demodulating the information from the selected channels.

2. The method of claim 1, wherein the demodulating the information from the selected channels comprises substantially concurrently demodulating the information from the selected channels.

3. The method of claim 1, wherein the demodulating the information from the selected channels comprises demodulating the information from the selected channels substantially concurrently in serial fashion using a single demodulator.

4. The method of claim 1, further comprising receiving ongoing channel selections from the two or more users.

5. The method of claim 1, where the receiving an EM band comprises receiving multiple EM bands.

6. The method of claim 1, where the receiving an EM band comprises using multiple modulation protocols, where the receiving two or more selections of two or more of the channels from the two or more users further comprises receiving two or more selections of two or more of the modulation protocols, and where the demodulating the information from the selected channels comprises demodulating the information from the selected channels using the multiple modulation protocols.

7. The method of claim 1, further comprising sending the demodulated information to the users according to the users' respective selections.

8. The method of claim 1, further comprising accepting an updated list of supported protocols and the protocols' respective methods for demodulation.

9. A device for processing an EM band, the device comprising:
one or more processors;
one or more memory units coupled to the one or more processors;
the device being configured to:
receive a digitized EM band comprising two or more channels where the two or more channels comprise modulated information;
receive two or more selections of two or more of the channels from two or more users; and
demodulate the information from the selected channels.

10. The device of claim 9, further comprising a vehicle, the vehicle comprising the device comprising:
one or more processors;
one or more memory units coupled to the one or more processors;
the device being configured to:
receive a digitized EM band comprising two or more channels where two or more channels comprise modulated information;
receive two or more selections of two or more of the channels from two or more users; and
demodulate the information from the selected channels.

11. The device of claim 9, wherein the device is configured to demodulate the information from the selected channels substantially concurrently.

12. The device of claim 9, wherein the device is configured to demodulate the information from the selected channels substantially concurrently in serial fashion using a single demodulator.

13. The device of claim 9, wherein the device is further configured to receive ongoing channel selections from the two or more users.

14. The device of claim 9, wherein the device is further configured to receive multiple EM bands.

15. The device of claim 9, wherein the device is further configured to receive multiple modulation protocols, wherein the device is further configured to receive two or more selections of two or more of the modulation protocols from the two or more users, and wherein the device is further configured to demodulate the information from the selected channels using the multiple modulation protocols.

16. The device of claim 9, wherein the device is further configured to send the demodulated information to the users according to the users' respective selections.

17. The device of claim 9, wherein the device is further configured to accept an updated list of supported protocols and the protocols' respective methods for demodulation.

18. A computer program product for processing an electromagnetic (EM) band, the computer program product being stored on a computer-operable medium and comprising software code being effective to:
receive a digitized EM band comprising two or more channels where the two or more of the channels comprise modulated information;
receive two or more selections of two or more of the channels from two or more users; and
demodulate the information from the selected channels.

19. The computer program product of claim 18, wherein the code is effective to demodulate the information from the selected channels substantially concurrently.

20. The computer program product of claim 18, wherein the code is effective to demodulate the information from the selected channels substantially concurrently in serial fashion using a single demodulator.

21. The computer program product of claim 18, wherein the code is further effective to receive ongoing channel selections from the two or more users.

22. The computer program product of claim 18, wherein the code is further effective to receive multiple EM bands.

23. The computer program product of claim 18, wherein the code is further effective to receive multiple modulation protocols, wherein the code is further effective to receive two or more selections of two or more of the modulation protocols from the two or more users, and wherein the code is further effective to demodulate the information from the selected channels using the multiple modulation protocols.

24. The computer program product of claim 18, wherein the code is further effective to send the demodulated information to the users according to the users' respective selections.

25. The computer program product of claim 18, wherein the code is further effective to accept an updated list of supported protocols and the protocols' respective methods for demodulation.
